(19) United States
(12) Patent Application Publication
(10) Pub. No.: US 2007/0281210 A1
(43) Pub. Date: Dec. 6, 2007

(54) Lithium secondary battery for operation over a wide range of temperatures

(76) Inventors: Vladimir Kolosnitsyn, Ufa (RU); Elena Karaseva, Ufa (RU)

Correspondence Address: PEARL COHEN ZEDEK LATZER, LLP, 1500 BROADWAY 12TH FLOOR, NEW YORK, NY, 10036, US

(21) Appl. No.: 11/806,982

(22) Filed: Jun. 5, 2007

Related U.S. Application Data
(63) Continuation-in-part of application No. PCT/GB07/50303, filed on May 30, 2007.
(60) Provisional application No. 60/836,972, filed on Aug. 11, 2006.

(30) Foreign Application Priority Data
Jun. 5, 2006 (GB) 0611009.2

(51) Int. Cl. H01M 4/58; H01M 4/60; H01M 4/40; H01M 4/62

(52) U.S. Cl. 429/218.1; 429/213; 429/231.95; 429/217

(57) ABSTRACT

A rechargeable cell for operation at temperatures above from −40° C. to +120° C. which has a positive electrode comprising sulfur and/or organic and/or non-organic compounds (including polymer compounds) of sulfur as an electrode active material, and a negative electrode made of metal lithium or lithium alloys, and an electrolyte comprising a solution of one or more salts in one or more solvents.

### PRIOR APPLICATION DATA

The present application is a continuation-in-part of prior International Application PCT/GB2007/050303 filed May 30, 2007, and also claims benefit of prior U.S. Provisional application 60/836,972 filed Aug. 11, 2006 and also prior UK application 0611009.2 filed Jul. 5, 2006, each of which being incorporated herein by reference.

### TECHNICAL FIELD

The present invention relates to electrochemical power engineering, and in particular to secondary (rechargeable) chemical sources of electric energy comprising a negative electrode (anode) made of lithium and/or lithium alloys, and a positive electrode (cathode) comprising sulfur and/or sulfur-based inorganic and/or organic (including polymeric) compounds as an electrode active material, which are capable of operating at low temperatures (e.g. down to −60° C.) as well as at high temperatures (up to +100° C. and, in some embodiments, up to +150° C.).

### BACKGROUND OF THE INVENTION

All secondary batteries which operate well at room temperature tend to perform badly at higher temperatures. They either have very poor charge-discharge characteristics or do not cycle at all. For example, at higher temperatures a quick self discharge occurs in nickel-metal hydride batteries due to the following reactions:
2NiOOH+H₂→2Ni(OH)₂ (at the positive electrode)
2NiOOH+H₂O→2Ni(OH)₂+½O₂ (at the negative electrode)

The self-discharge rate of nickel-metal hydride batteries builds up quickly with temperature and reaches 70% per month at +45° C. (“Batteries for portable device”; G. Pistoia; Elsevier 2005; p. 103). Moreover nickel-metal hydride batteries are almost incapable of accepting charge at higher temperatures (over +50 or +60° C.). Accordingly, nickel-metal hydride batteries can only be fully discharged at elevated temperatures, and are to be charged and stored at room (or slightly lower) temperatures.

Similar considerations apply for lithium-ion batteries. In practice, these do not take charge at temperatures higher than +60° C. The capacity of Li-ion batteries quickly degrades when they are cycled at elevated temperatures. For example, the capacity of a typical Li-ion battery fades 15% each cycle when charged and discharged at a rate of 0.5 C (2 hours charge, discharge time) in a voltage range from 4.3 to 3.5 V at a temperature of +55° C.

Furthermore, at higher temperatures, electrolytes of Li-ion batteries enter react with the positive and negative electrodes which results in the formation on the electrode surfaces of hard passivating films which causes a sharp increase in the internal resistance of the battery.

Electrochemical systems comprising active materials with moderate oxidizing properties and low electrochemical equivalents (the “electrochemical equivalent” of a substance is the mass of the substance, in grams, which is liberated or consumed by the passage of 1 coulomb of electricity) are expected to be the most appropriate for higher temperature applications.

### SUMMARY

According to a first aspect of the present invention, there is provided a rechargeable cell for operation at temperatures above 60° C. which has a positive electrode comprising sulfur and/or organic and/or non-organic compounds (including polymer compounds) of sulfur as an electrode active material, and a negative electrode made of metal lithium or lithium alloys, and an electrolyte comprising a solution of one or more salts in one or more solvents.

Preferred embodiments utilize a lithium-sulfur electrochemical system for use in secondary (rechargeable) batteries adapted for charging and discharging at higher temperatures. To provide good battery performance at higher temperatures it is suggested to use as battery components only such materials that have prolonged chemical and phase stability throughout the desired operating temperature range.

Suitable binders for the positive electrodes of lithium-sulfur batteries embodying the present invention include polymers having a rubbery flow region temperature higher than the operating temperature of the battery. The rubbery flow region is the temperature range in which a polymer displays both rubber elasticity and flow properties. Preferred polymers include fluorocarbon polymers, polyolefins and polynitriles, among others, including polyacrylate, polyamide and polyvinylchloride.

Suitable components for the electrolyte solutions (solvents and salts) for high temperature lithium-sulfur batteries include those which possess high thermal and chemical stability against metal lithium and sulfur. Furthermore, to provide the desired wide operating temperature range it is suggested to use solvents which are in the liquid state over the desired temperature range. Organic carbonates, glymes, sulfones, γ-butyrolactone and/or dimethyl sulfoxide can be used as solvents and lithium hexafluorophosphate, lithium tetrafluoroborate, lithium triflate, as well as lithium chloride, lithium bromide and lithium iodide can be used as salts.

One embodiment of the invention includes a rechargeable cell for operation at temperatures above from about −40° C. to +120° C., the cell including a positive electrode comprising an electrode active material comprising one or more substances selected from the group consisting of: sulfur, organic compounds of sulfur, non-organic compounds of sulfur, and polymer compounds of sulfur; a negative electrode made of metal lithium or lithium alloys; and an electrolyte comprising a solution of one or more salts in one or more solvents. The positive electrode may include an electrode active material comprising sulfur, organic compounds of sulfur, non-organic compounds of sulfur, polymer compounds of sulfur, or their combination. The positive electrode active material may include polymers functioning as binding materials having rubbery flow region temperature higher than the operating temperature of the cell. The positive electrode active material may include polymers functioning as binding materials possessing thermal stability at the operating temperature of the battery. The electrolyte solvent may include an aprotic dipolar solvent having a melting temperature at least 10° C. lower than the operating temperature of the cell. The aprotic dipolar solvent may have a melting temperature about 10° C. to 20° C. lower than the operating temperature of the cell. The electrolyte solvent may include an aprotic dipolar solvent having thermal stability at the operating temperature of the cell. The electrolyte solvent may include an aprotic dipolar solvent that is stable with respect to metal lithium at the operating temperatures of the cell. The electrolyte salt may include one or more salts having thermal stability at the operating temperature of the cell. The electrolyte salt may include one or more salts having stability with respect to metal lithium at the operating temperature of the cell. The cell may be adapted for charging at a temperature from about −40° C. to +120° C. The cell may be adapted for discharging at a temperature from about −40° C. to +120° C. The cell may be adapted for prolonged cycling at a temperature from about −40° C. to +120° C. The cell may be adapted for operation at temperatures above about +60° C.

One embodiment includes a rechargeable cell for operation at temperatures from, for example, about −40° C. to +120° C., including an electrolyte solution comprising one or more salts dissolved in one or more solvents, in which embedded are: a positive electrode comprising an electrode active material comprising sulfur, organic compounds of sulfur, non-organic compounds of sulfur, polymer compounds of sulfur, or their combination; and a negative electrode made of metal lithium or lithium alloys. Other operating temperatures, such as those described herein or other temperatures, may be used.

The positive electrode active material may include polymers functioning as binding materials having a glass transition temperature (Tg) higher than the higher limit of the operating temperature range of the cell.

The positive electrode active material may include one or more substances from the group consisting of: sulfur-containing fluoropolymers, polyolefins, polynitriles, polyacrylates, polyamides and polyvinylchlorides. The electrolyte solvent may be selected from the group consisting of: organic carbonates, glymes, sulfones, γ-butyrolactones and dimethyl sulfoxides. The electrolyte salt may be selected from the group consisting of: lithium hexafluorophosphate, lithium tetrafluoroborate, lithium triflate, lithium chloride, lithium bromide and lithium iodide.

The positive electrode active material may be for example sulfur-containing fluoropolymers, polyolefins, polynitriles, polyacrylates, polyamides or polyvinylchlorides. The electrolyte solvent may be for example organic carbonates, glymes, sulfones, γ-butyrolactones or dimethyl sulfoxides. The electrolyte salt may be for example lithium hexafluorophosphate, lithium tetrafluoroborate, lithium triflate, lithium chloride, lithium bromide or lithium iodide.

### BRIEF DESCRIPTION OF THE DRAWINGS

FIGS. 1-3 each depict a charge-discharge curve and capacity fade according to various embodiments.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well known features may be omitted or simplified in order not to obscure embodiments of the invention described herein.

The lithium-sulfur electrochemical system looks very promising for use at elevated temperatures. Indeed, sulfur has a relatively low redox potential (2.52V relative to a lithium electrode) and a low electrochemical equivalent: 16 g/F. Elemental sulfur is poorly soluble in aprotic dipolar solvents and electrolytic systems based thereon. The end product of sulfur electrochemical reduction, lithium sulfide, is poorly soluble in electrolytic systems based on aprotic dipolar solvents.

Lithium-sulfur batteries are known as batteries with liquid cathodes due to the high solubility of lithium polysulphides (in most aprotic electrolytes), which are produced on the positive electrode during charge and discharge; though the cathode active material in its fully oxidized state (elemental sulfur), and in its fully reduced state (lithium sulfide) are present in the positive electrode in a solid phase.

The possibility to operate rechargeable batteries at higher temperatures is determined on the one hand by the thermal stability of the reagents used as active materials of the positive and negative electrodes, electrolytes, separators and other structural materials, and on the other hand by the rates of the corrosion processes (self-discharge) on the positive and negative electrodes.

The presence of lithium polysulfides in electrolytes of lithium-sulfur batteries has an important effect on the behaviour of the electrochemical system based on lithium-sulfur.

Lithium polysulfides are compounds with a gross composition that can be described by the formula Li₂Sₙ. Oxidation of low- and medium-chain lithium polysulfides to long-chain lithium polysulfides occurs on the positive electrode when a lithium-sulfur cell is charged. The maximal length of a polysulfide chain (the maximum value of the “polysulfidity” degree−n) is determined by the properties of the electrolyte system, namely the solvents and the base (background) salts, and can take a value from 2 to 10 and more. As an example, the maximal length of polysulfides in sulfolane is 6 independently from the polysulfide concentration. The polysulfide concentration and composition in the electrolytes of lithium-sulfur batteries are determined by the charge-discharge state of the battery, by physical-chemical properties of the electrolyte system and by the temperature. It is necessary to note that the temperature dependence of the polysulfide solubility significantly varies with the nature of the solvent. The lithium polysulfide solubility decreases with temperature in some solvents.

After the maximum possible polysulfide length is reached, further electrochemical oxidation leads to the formation of elemental sulfur, which is poorly soluble and hence is deposited onto the positive electrode. The sulfur precipitation at the surface of the positive electrode causes strong polarization producing a fast voltage buildup in a lithium-sulfur cell. Charging of lithium-sulfur batteries is usually stopped when a certain voltage is reached.

However, the precipitation of elemental sulfur onto the surface of the positive electrode does not occur in all conditions (systems). The deposition of elemental sulfur may not happen in some electrolytes because sulfur can be quickly taken away to the bulk of the electrolyte.

Cathodic deposition of metal lithium takes place at the negative electrode during charging of lithium-sulfur cells. Lithium can be plated or deposited either in a compact form, well bound to the surface, or in dendritic form. When dendrites are formed, only a small number of the dendrites have direct electrical contact with the electrode surface and are thus capable of taking part in the subsequent stages of the electrochemical reactions. The greater part of the dendritic lithium does not have electrical contact with the electrode and hence cannot take part in electrochemical reactions.

Lithium polysulfides dissolved in the electrolyte possess significant chemical activity to metal lithium. As a result, in addition to the electrochemical processes on the lithium metal surface, chemical reactions also take place causing a corrosion of the lithium electrode. The interaction rate of lithium polysulfides with metal lithium (the corrosion rate) determines the self discharge of a lithium-sulfur cell.

The interaction rate of lithium polysulfides with metal lithium depends on the concentration, composition (the degree of “polysulfidity”), and on the active surface area of the metal lithium. Dendritic lithium has a large surface area, hence it is capable of interacting actively with lithium polysulfides.

The interaction of metal lithium with long-chain lithium polysulfides results in an increase in the degree of sulfur reduction and in the formation of smaller chain polysulfides (short-chain lithium polysulfides), as well as in the formation of lithium sulfide, which is poorly soluble in aprotic solvents. Lithium sulfide in turn is deposited onto the surface of the lithium electrode producing a passivating film. Though such a film may slow down the corrosion rate, it does not stop electrochemical processes. Besides, it should be noted that a lithium sulfide film on the surface of a lithium electrode decreases the reduction degradation of electrolyte systems which is especially important at higher operating temperatures. The thickness of a passivating film depends on the composition and concentration of lithium polysulfides in the electrolyte solution. The lower the concentration and the chain length of lithium polysulfides, the thicker the passivating film.

In one embodiment, the operating temperature of embodiments of the present invention is room temperature, for example approximately 25 degrees Celsius. Other operating temperatures may be used, for example over 60 degrees Celsuis, or other temperatures described herein. For example, operating temperature may be between 15 and 35 degrees Celsius. An operating temperature may be between 10 and 40 degrees Celsius. In one embodiment, a device or method according to an embodiment of the invention may operate at temperatures from about −40° C. to +120°° C. Other operating temperatures may be used.

The reactions on the lithium electrode in electrolyte solutions comprising lithium polysulfides can be described by two equations:
2Li+Li₂Sₙ→Li₂S↓+Li₂Sₙ₋₁, (1)
2Li+Li₂Sₙ→Li₂S₂↓+Li₂Sₙ₋₂, (2)

Lithium sulfide and disulfide can produce a passivating layer during deposition onto the surface of a metal lithium electrode. This layer slows down or completely prevents further interaction of metal lithium with components of the electrolyte system.

However lithium sulfide and disulfide are also capable of interacting with lithium polysulfides (equations 3 and 4) producing medium-chain lithium polysulfides soluble in electrolyte:
Li₂S+Li₂Sₙ→Li₂Sₖ+Li₂Sₙ₋ₖ₊₁, (3)
Li₂S₂+Li₂Sₙ→Li₂Sₖ+Li₂Sₙ₋ₖ₊₂, (3)

Medium-chain (not saturated) lithium polysulfides can interact with elemental sulfur to produce long-chain lithium polysulfides:
Li₂Sₙ₋₁+S→Li₂Sₙ. (5)

As a result, the state of the lithium electrode surface, and the presence and composition of a surface film thereon are determined by the composition and concentration of lithium polysulfides in electrolytes of lithium sulfur cells. In turn, the electrolyte composition in a lithium-sulfur battery is determined by the physical-chemical properties of solvents and of base (background) salts, by the charge-discharge state of the lithium-sulfur battery and by its operating mode.

The presence of lithium polysulfides in electrolyte systems and their reactivity with metal lithium and elemental sulfur result in a shuttle process of sulfur transfer, the so-called “sulfur cycle”, between the positive and negative electrodes of lithium-sulfur batteries.

The shuttle transfer of sulfur results from the direct reduction of sulfur being a part of polysulfide compositions. It is a complex process that includes several stages.

Firstly, lithium sulfides from the passivating film on the surface of metal lithium start to interact with long-chain lithium polysulfides from the electrolyte. This reaction results in the formation of medium-chain lithium polysulfides, which are well soluble in the electrolyte. This leads to the partial or full dissolution of the protective sulfide film from the surface of the metal lithium, which causes a direct interaction of metal lithium with lithium polysulfides.

Simplified reactions at the electrodes causing the shuttle sulfur transfer can be described by the following equations:

At the negative electrode:
2Li+Li₂Sₙ→2Li₂S_{n/2} (6)

At the positive electrode:
Li₂S_{n/2}+n/2S→Li₂Sₙ (7)

The “sulfide cycle” (the shuttle sulfur transfer) has a double effect on the properties of lithium-sulfur batteries.

On one hand, lithium-sulfur batteries can withstand a long overcharge due to the sulfide cycle. On the other hand, the shuttle sulfur transfer causes self-discharge. The rate of the shuttle sulfur transfer determines the self-discharge rate of a lithium-sulfur cell.

The rate of interaction of the lithium polysulfides with metal lithium is also determined by the form of metal lithium present at the negative electrode of a lithium-sulfur battery.

Typically a lithium-sulfur cell utilizes a metal lithium foil as the negative electrode. Because lithium tends to form dendrites during cycling, pristine metal lithium is gradually dispersed into metal lithium powder characterized by a highly developed surface area (dendritic lithium). The rate of pristine metal lithium dispersion (the rate of dendrite formation) over the cycle life depends to a large extent on the properties of the electrolyte system used as well as on lithium electrode surface cleanliness, i.e. on possible impurities on its surface. Substances physically blocking the electrode surface and preventing the electrochemical processes can be characterized as pollutants. Even a small quantity of such pollutants on a metal lithium surface may dramatically lower the efficiency of compact lithium cathode deposition. In this case, most of the lithium may become dendritic.

The increase of lithium surface area due to its dispersion causes an increase in the rate and the depth of the reduction of the lithium polysulfides and in an intense formation of lithium sulfide and disulfide, both of which are poorly soluble compounds. Lithium sulfide and disulfide precipitate onto the metal lithium in the form of powder and pollute its surface. A solid phase formation on the lithium surface (dendritic lithium, lithium sulfide and lithium disulfide) pollutes and provokes further dendrite formation at the cathode deposition of lithium.

Formation of lithium sulfide and disulfide on the negative electrode removes some of the sulfur from the lithium-sulfur electrochemical system causing a capacity fade, i.e. loss of charge and discharge capacity over the cycle life.

These phenomena taking place during cycling of lithium electrodes in electrolytes containing lithium polysulfides represent a positive feedback loop between the intensity of dendrite formation and the capacity fade.

The more dendrites are formed on the lithium electrode surface (during the lithium-sulfur battery charge), the higher is the rate of its interaction with lithium polysulfides dissolved in the electrolyte. The higher the rate of lithium polysulfide interaction With dendritic lithium, the more lithium sulfide and disulfide are formed. The more lithium sulfide and disulfide are formed, the more polluted is the lithium electrode surface. The more polluted the lithium electrode surface becomes, the more dendrites are formed during the lithium-sulfur battery charge. The more dendrites are formed, the more sulfur is consumed for the lithium sulfide and disulfide formation, and the higher the capacity fade becomes.

At the same time, the sulfur transfer can go not only from the positive electrode to the negative electrode, but also in the opposite direction. This will happen only when well-soluble compounds, mid-chain lithium polysulfides, are formed during the interaction of lithium polysulfides in the electrolyte (in addition to formation of poorly soluble lithium sulfide and disulfide). The formation of soluble components during the reaction of the dendritic lithium with lithium polysulfides may slow down the rate of capacity fade and may ultimately stabilize the capacity of a lithium-sulfur cell during charge-discharge.

In other words, the operational properties of the lithium-sulfur system including its high temperature performance significantly depend on the chemical, physical-chemical and electro-chemical processes running both on the negative (lithium) electrode and on the positive electrode in the presence of electrolyte systems containing lithium polysulfide solutions.

To ensure optimal or at least effective performance (low self discharge, high capacity and longer cycle life) of a lithium-sulfur cell at higher temperatures it is important that the rates of corrosion processes on the electrodes (responsible for the self-discharge) are significantly lower than the rates of the charge and discharge processes. Otherwise the capacity would be wasted mostly for self-discharge.

The self-discharge rate is determined by the rate of shuttle sulfur transfer. It increases with temperature resulting in an increase in the rate of self-discharge.

To reduce the rate of self discharge and to provide better performance of lithium-sulfur batteries at higher temperatures, it is proposed by the present applicant to use electrolytes that, at higher temperatures, promote the formation of a protective passivating film on the lithium electrode having predetermined preferred properties, including: high ion conductivity, relatively low solubility in polysulfide systems and high protective properties against the electrolyte.

The performance of a lithium-sulfur battery at higher temperatures is determined not only by the electrochemical properties of the lithium-sulfur electrochemical system, but also by the thermal properties of the battery components and especially by the thermal properties of the electrolyte components, solvents and salts, as well as by the thermal properties of any binder materials.

As a binder material for lithium-sulfur batteries designed for higher temperature performance, it is suggested to use polymers with a rubbery flow region temperature which is higher than the working temperature of the battery. Such polymers can be selected from but not limited to: fluoropolymers, polyolefines, polynitriles and others, including polyacrylate, polyamide and polyvinylchloride.

For electrolyte solvents and salts for lithium-sulfur batteries designed for the operation at higher temperatures, it is suggested to use compounds possessing thermal and chemical stability towards metal lithium and sulfur. In addition, to provide wider operating temperature ranges it is suggested to choose solvents that are in the liquid phase over the desired temperature range. Such solvents for electrolytes of lithium-sulfur batteries can be selected from but not limited to: organic carbonates, glymes and sulfones, while the salts can be selected from but not limited to: lithium hexafluorophosphate, lithium tetrafluoroborate, lithium triflate, lithium chloride, lithium bromide, and lithium iodide.

### EXAMPLES

The following examples are examples only, and are non-limiting.

### Example 1

An electrode comprising 70% elemental sulfur, 20% carbon and 10% polytetrafluoroethylene (PTFE) as a binder was produced as follows.

3.5 g of sublimated sulfur, 99.5% (available from Fisher Scientific, Loughborough, UK) and 1.0 g of carbon black (Ketjenblack EC-600JD, available from Akzo Nobel Polymer Chemicals BV, Netherlands) were placed into an agate mortar and ground carefully to obtain a homogeneous composition.

20 ml of isobutanol were added to 1 ml of a 50% aqueous suspension of polytetrafluoroethylene (PTFE) and mixed carefully to obtain a homogeneous semitransparent white gel.

This gel was then added to the dry sulfur/carbon mixture and further ground carefully to produce a homogeneous plastic paste. Two carbon strips, 50 μm thick and 40 mm wide, were produced from the paste described above by using a roller press. Then the strips were soaked in isobutanol for 30 minutes. Sulfur electrodes were manufactured by sandwiching an aluminum grid between the two soaked carbon strips and compressing between the rolls of a roller press. The thickness of the electrode thus produced was 100 μm, with a porosity of 74% and a surface capacity of 6.3 mAh/cm².

### Example 2

The sulfur electrode from Example 1 was installed in a small laboratory prototype cell placed in a stainless steel housing. The surface area of the electrode was about 5 cm².

The sulfur electrode was dried out under vacuum at +50° C. for 24 hours. A porous separator, Celard®3501, was used (a trade mark of Tonen Chemical Corporation, Tokyo, Japan, also available from Mobil Chemical Company, Films Division, Pittsford, N.Y.). A 38 μm thick lithium foil (from Chemetall Foote Corp.) was used as the negative electrode. A 1.0M solution of lithium trifluoromethanesulfonate (available from 3M Corporation, St. Paul, Minn.) in sulfolane was used as an electrolyte.

The cell was assembled in the following way. The initially dried out sulfur electrode was placed into the cell housing. Then the separator was placed onto the electrode. The electrolyte was deposited onto the separator by a syringe in a quantity sufficient for the separator to be fully soaked. After that, the lithium electrode was placed onto the separator and the cell was hermetically sealed in a stainless steel housing. The cell was kept at room temperature for 24 hours before being put on charge-discharge cycling.

### Example 3

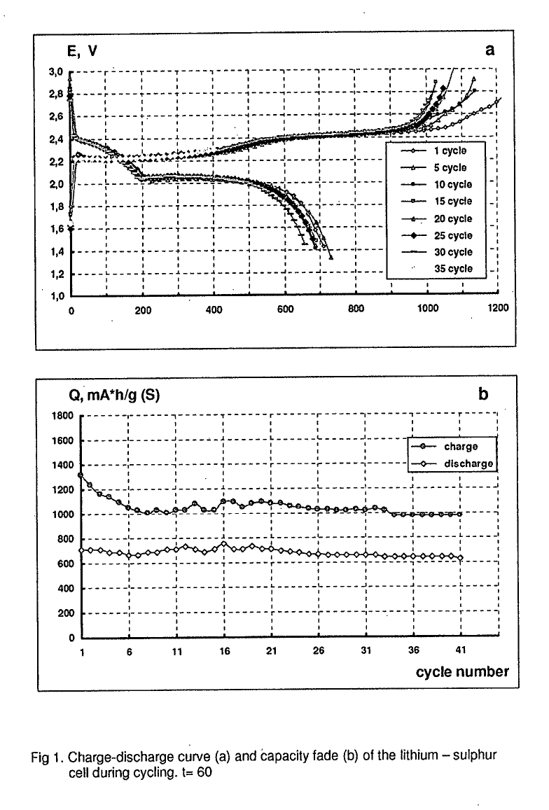

The cell from Example 2 was placed into an air thermostat and stored at a temperature of +60° C. for 5 hours and then put on charge and discharge cycling. The cell was charged and discharged at a load of 0.3 mA/cm² with charge and discharge termination at 2.8V and 1.5V respectively. The charge-discharge curves obtained are shown in FIG. 1.

The charge-discharge curves demonstrate that the lithium-sulfur cell can be cycled at 60° C. without any significant loss of capacity.

### Example 4

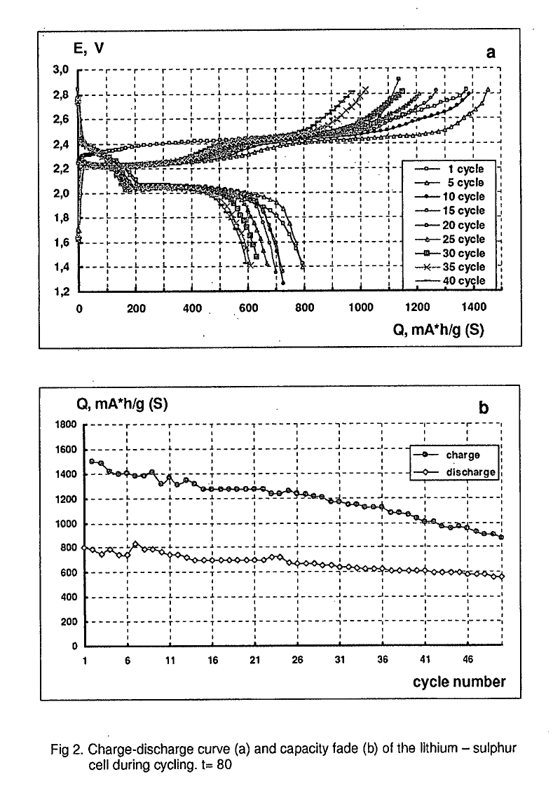

The cell from Example 2 was placed into an air thermostat and stored at a temperature of +80° C. for 5 hours and then put on charge and discharge cycling. The cell was charged and discharged at a load 0.3 mA/cm² with charge and discharge termination at 2.8V and 1.5V respectively. The charge-discharge curves obtained are shown in FIG. 2.

The charge-discharge curves demonstrate that the lithium-sulfur cell can be steadily cycled at 80° C., the loss of its capasity being 0.5% per cycle.

### Example 5

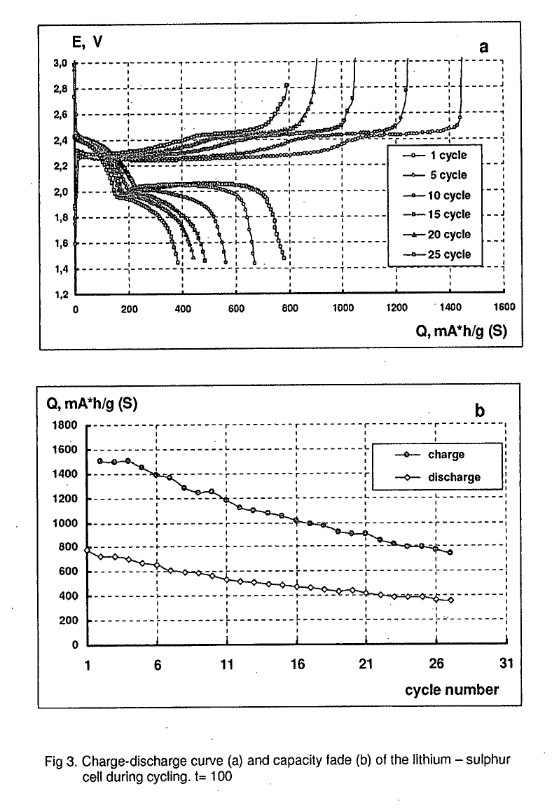

The cell from Example 2 was placed into an air thermostat and stored at a temperature of +100° C. for 5 hours and then put on charge and discharge cycling. The cell was charged and discharged at a load 0.3 mA/cm² with charge and dischage termination at 2.8V and 1.5V respectively. The charge-discharge curves obtained are shown in FIG. 3.

The charge-discharge curves demonstrate that the lithium-sulfur cell can be cycled at 100° C., the loss of capacity being 2.5% during the first 15 cycles and 1% on the following 15 cycles.

The examples above demonstrate that lithium-sulphur cells can be steadily cycled at higher temperatures.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A rechargeable cell for operation at temperatures from about −40° C. to +120° C. comprising:
an electrolyte solution comprising one or more salts dissolved in one or more solvents, in which embedded are:
a positive electrode comprising an electrode active material comprising sulfur, organic compounds of sulfur, non-organic compounds of sulfur, polymer compounds of sulfur, or their combination; and
a negative electrode made of metal lithium or lithium alloys.

2. A cell as claimed in claim 1, wherein the positive electrode active material comprises polymers functioning as binding materials having rubbery flow region temperature higher than the operating temperature of the cell.

3. A cell as claimed in claim 1, wherein the positive electrode active material comprises polymers functioning as binding materials possessing thermal stability at the operating temperature of the battery.

4. A cell as claimed in claim 1, wherein the electrolyte solvent includes an aprotic dipolar solvent having a melting temperature at least 10° C. lower than the lower limit of the operating temperature range of the cell.

5. A cell as claimed in claim 4, wherein the aprotic dipolar solvent has a melting temperature 10° C. to 20° C. lower than the lower limit of the operating temperature range of the cell.

6. A cell as claimed in claim 1, wherein the electrolyte solvent includes an aprotic dipolar solvent having thermal stability at the operating temperature range of the cell.

7. A cell as claimed in claim 1, wherein the electrolyte solvent includes an aprotic dipolar solvent that is stable with respect to metal lithium at the operating temperature range of the cell.

8. A cell as claimed in claim 1, wherein the electrolyte salt comprises one or more salts having thermal stability at the operating temperature range of the cell.

9. A cell as claimed in claim 1, wherein the electrolyte salt comprises one or more salts having stability with respect to metal lithium at the operating temperature range of the cell.

10. A cell as claimed claim 1, adapted for charging at a temperature from −40° C. to +120° C.

11. A cell as claimed in claim 1, adapted for discharging at a temperature from −40° C. to +120° C.

12. A cell as claimed in claim 1, adapted for prolonged cycling at a temperature from −40° C. to +120° C.

13. A cell as claimed in claim 1, adapted for operation at temperatures above +60° C.

14. A cell as claimed in claim 1, wherein the positive electrode active material is sulfur-containing fluoropolymers, polyolefins, polynitriles, polyacrylates, polyamides or polyvinylchlorides.

15. A cell as claimed in claim 1, wherein the electrolyte solvent is organic carbonates, glymes, sulfones, γ-butyrolactones or dimethyl sulfoxides.

16. A cell as claimed in claim 1, wherein the electrolyte salt is lithium hexafluorophosphate, lithium tetrafluoroborate, lithium triflate, lithium chloride, lithium bromide or lithium iodide.

17. A cell as claimed in claim 1, wherein the positive electrode active material comprises polymers functioning as binding materials having a glass transition temperature (Tg) higher than the higher limit of the operating temperature range of the cell.
